(19) United States
(12) Patent Application Publication
(10) Pub. No.: US 2017/0246673 A1
(43) Pub. Date: Aug. 31, 2017

(54) RAPID PROTOTYPE STAMPING TOOL FOR HOT FORMING OF ULTRA HIGH STRENGTH STEEL MADE OF ALUMINUM

(71) Applicant: Ford Global Technologies, LLC, Dearborn, MI (US)

(72) Inventors: Maik Broda, Würselen (DE); Raymund Eugen Pflitsch, Engelskirchen (DE); Clemens Maria Verpoort, Monheim am Rhein (DE); Raphael Koch, Odenthal (DE); Michael Brose, Pulheim (DE)

(73) Assignee: Ford Global Technologies, LLC, Dearborn, MI (US)

(21) Appl. No.: 15/430,964

(22) Filed: Feb. 13, 2017

(30) Foreign Application Priority Data
Feb. 29, 2016 (DE) 102016203195.3

(51) Int. Cl. B21D 37/01; C25D 11/12; C25D 11/02; C25D 11/18; B21D 22/02; B23P 15/24

(52) U.S. Cl. CPC B21D 37/01; B21D 22/02; B23P 15/24; C25D 11/026; C25D 11/18; C25D 11/12

(57) ABSTRACT

A method for producing a forming tool having a forming punch and a mating die corresponding to the forming tool for forming a substrate is provided, which includes the steps of preparing at least the forming punch of the forming tool from a light metal and forming a protective coating on at least one region on a surface of at least the forming punch of the forming tool. The protective coating is applied to a region that is configured to contact the substrate, and in one form, the light metal is aluminum or an aluminum alloy. A forming tool having a forming part and a mating die is also provided, in which at least the forming tool is made from a light metal and includes the protective coating.

### CROSS-REFERENCE TO RELATED APPLICATIONS

This application is a claims the benefit of DE 102016203195.3 filed on Feb. 29, 2016. The disclosure of the above application is incorporated herein by reference in its entirety.

### FIELD

The present disclosure relates to a method for producing a forming tool having a forming punch and a mating die corresponding thereto. However, the invention is also directed to a forming tool of this kind.

### BACKGROUND

The statements in this section merely provide background information related to the present disclosure and may not constitute prior art.

A method for producing a hot foil stamping block, that is to say, for example, a punching tool, is disclosed in DE 37 08 368 C1, although this is used to produce printed circuits.

DE 10 2011 007 424 B4 discloses a method for producing a coating on the surface of a substrate based on light metals by plasma electrolytic oxidation and a coated substrate. The substrate is dipped into a liquid electrolyte as an electrode together with a counterelectrode. A sufficiently high voltage to produce a spark discharge is applied across the surface of the substrate. The electrolyte contains dispersed clay particles. This is intended to improve the corrosion protection of the light metal components, especially those made of magnesium or magnesium alloys.

In many cases, load-bearing steel components, such as body components in the automotive industry, that is to say, for example, A, B, C or D pillars, but also components such as sills, a frame part and/or bumper supports, are produced from high-strength heat-treated steels, such as boron-alloyed steel, e.g. 22MnB5. In this case, as WO2007/076766 A1 discloses, the steel is converted to the austenitic range by annealing at temperatures above 800° to 900° C., is hot-formed and is then cooled again at a sufficiently high cooling rate to achieve the formation of a martensitic high-strength microstructure. If quenching, i.e. cooling and thus hardening, takes place in the forming tool, the term “press hardening” is used.

In a direct forming process such as that disclosed in WO2007/076766 A1, for example, a blank or a steel element separated from a rolled strip is first of all brought to said temperature. The heated preform is then transferred to the subsequent hot forming system and is brought to the final shape there in the heated state, e.g. in a press. In an indirect forming process, on the other hand, the steel element is first of all cold-formed in a first press, then heated, that is to say probably annealed, and is then hot-formed in another press, i.e. brought to the final shape.

The press can also be referred to as a forming tool and has a forming punch and a mating die corresponding thereto. The forming tool is produced, that is to say, for example, cast, from a correspondingly durable material, preferably steel. After the forming tool, that is to say, for example, the forming punch or the mating die corresponding thereto has in each case been cast as a preform, it requires finishing to give the required final shape, e.g. by means of a CNC method. This is a prolonged and expensive process. It may be that production of the forming tool takes several months, that is to say, for example, up to three months. Moreover the selected material for the forming tool must be able to withstand a high temperature since the substrate to be formed, as described above, is brought to temperatures above 900° C., for example. It is apparent that such forming tools are very heavy and require a correspondingly designed control device to even be able to move the considerable masses. Such devices are obviously very expensive but also very energy-intensive during the operation thereof. The forming tool must possibly be coated as well in order, for example, to be corrosion-resistant or resistant to scale formation, while the properties of the steel sheet to be formed and the material thereof should not be negatively affected. A coating of this kind can be applied by means of a thermal spraying method, e.g. by means of a plasma powder spraying method.

In US 2010/0159264 A1 there is a disclosure, for example, that protective coatings for casting molds are advisable in order to be able to avoid premature replacement of the casting molds, for example. The corrosive property of molten aluminum, in particular, is discussed in US 2010/0159264 A1, this having previously reduced the service life of casting molds considerably. In this context, US 2010/0159264 A1 mentions that antiwear, antierosion or anticorrosion coatings for casting molds can admittedly be applied to the surface of the casting mold in a known manner by means of CVD (Chemical Vapor Deposition) or PVD (Plasma Vapor Deposition) methods. However, this is said to be challenging in situ from an economic point of view. Moreover, protective coatings applied by the CVD or PVD method could flake off during operation. For this reason, US 2010/0159264 A1 proposes a protective coating which has a thin layer of transition metal oxides or rare earth metal oxides, that is to say, for example, zirconium or cerium or mixed compounds thereof, which are supposed to prevent adhesion of the molten metal to the casting mold. In particular, such coatings are said to be expedient in the case of aluminum casting or aluminum melting processes. The heat input for the application of the protective coating is also said to be lower than with PVD or, especially, CVD methods, which are supposed to subject the parent material of the molds to temperatures of as much as 900° C. to 1000° C. According to US2010/0159264 A1, the coating composed of metals of the carboxyl group was applied with subsequent heat treatment of at least 400° C.

Surface treatments for metallic substrates or casting molds are therefore known. For example, enamel has also been known for a long time as a protective coating. In enameling, objects are provided with a layer of enamel by dipping or spraying and are then fired at a temperature of from 800 to 850° C. Layers of enamel can be applied to steel, for example, but are easily damaged and are therefore susceptible to impact. For press tools, enameling is therefore probably unsuitable. Moreover, enameling is very energy-intensive, wherein the heat introduced into the component to be coated also has a disadvantageous effect on the original mechanical properties of the material thereof, this being the case especially with light metal components. Another known process for light metal components, that is to say, for example, aluminum components, is anodizing, i.e. electrolytic oxidation, as a result of which the anodized surfaces are very hard. In this process, in contrast to electrodeposition methods, the protective layer is not deposited on the workpiece but is formed by converting the uppermost metal layer into an oxide or hydroxide.

Plasma electrolytic oxidation (PEO) of aluminum is furthermore known. Plasma electrolytic oxidation can produce layer hardnesses of 2000 HV (Vickers Hardness). In the majority of cases, alkaline silicate or phosphate solutions are used as electrolytes, as DE 10 2011 007 424 B4 discloses.

Thus, there is room for improvement in the production of forming tools and in such forming tools.

### SUMMARY

The present disclosure provides a method to produce a forming tool easily and in a time-saving manner while, at the same time, one which is durable. A forming tool produced from such a method is also provided by the present disclosure.

Attention is drawn to the fact that the features and measures presented individually in the following description can be combined in any desired, technically feasible way and give rise to further forms of the present disclosure.

According to the present disclosure, the method comprises the steps of:

preparing at least a forming punch of the forming tool from a light metal, by means of which a substrate is to be formed; and

producing a protective coating at least on one surface region of the at least of the forming punch of the forming tool, which comes into contact with the substrate to be formed.

Thus, by means of the present disclosure, a forming tool is expediently produced, preferably cast, from a light metal, e.g. from aluminum or from an aluminum alloy. Thus, as used herein, the term “light metal” should be construed to mean a metal that has a density lower than that of steel. In this case, the forming tool has the forming punch and the mating die corresponding thereto. In particular, the forming punch can be produced from the light metal. Thus, in comparison with a forming tool made of steel, a very light forming tool is formed. This requires a correspondingly reduced control device, which has to move less mass, although it is possible to form high-strength heat-treated steels, e.g. from boron-alloyed steel, e.g. 22MnB5, using the forming tool according to the present disclosure.

For this purpose, a protective coating, in particular a heat protection coating, is applied at least to the surface of the forming tool which can come into contact with the substrate to be formed. The mating die can also be produced from the light metal. If the mating die is held in a fundamentally immovable manner, it can also be produced from a steel. At the same time, the advantage as regards the control device is maintained since only the forming punch has to be moved relative to the mating die. However, it is also expedient to produce the immobile mating die from the light metal as well, and further details of this will be given below.

It is expedient if the protective coating is applied by means of plasma electrolytic oxidation (PEO), i.e. microarc oxidation (MAO) or plasma electrolytic deposition (PED).

A prerequisite for plasma electrolytic oxidation (PEO) is the formation of an oxide layer (dielectric) in an electrolyte. In this case, the forming tool element to be coated, that is to say, for example, the forming punch and also the mating die, is dipped at least partially in the electrolyte and connected as electrode. A counterelectrode likewise dips into the electrolyte. Of course, the elements of the forming tool can be connected as counterelectrodes, while an electrode also dips into the electrolyte. Maintenance of a current can thus lead to a voltage rise and discharge. In most cases, an electric voltage of at least 250 V is desired, leading to a spark discharge at the surfaces of the forming tool. During this process, there is local plasma formation. The layers are formed by microdischarges, which melt the parent material of the forming tool and reaction products of the electrolyte together with the light metal and sinter to form a crystalline ceramic. In this way, it is possible to produce a protective coating, in particular a heat protection and/or antiwear coating on those regions of the forming tool which are to be coated. The coating applied can have a hardness of up to 2000 HV. A uniform coating with a definable layer thickness is formed, wherein the protective coatings can be from 10 μm to 200 μm, and in one form from 50 μm to 100 μm. The coating applied according to the present disclosure is chosen and produced in such a way that the coated forming tool can withstand very high temperatures and, in all cases, at least the austenitization temperature of the substrate to be formed. Changes in the coating are not observed during this process. This also means that the forming tool produced from the light metal, in its entirety, can withstand the effect of a considerable temperature without impairment of the coating or of the parent material. It is also in accordance with the present disclosure to perform hard anodizing in order to arrange the protective coating on the forming tool.

If both the forming punch and the mating die corresponding thereto are formed from the light metal, both elements are also coated by means of PEO/PED, at least in some region or regions.

It is expedient if only the respectively affected surfaces, those which also have contact with the substrate to be formed, are coated by means of PEO. As already mentioned, the substrate can be a steel sheet composed of high-strength heat-treated steel. One surface thereof makes contact with the forming punch and the opposite surface thereof makes contact with the surface of the corresponding mating die. It is, of course, also possible to coat the entire forming tool, i.e. both the forming punch and the mating die, completely in each case. However, it is expedient if only those regions or surfaces which are in contact with the substrate to be formed are coated by means of PEO or PED. This saves time and is also less expensive.

The coating process can be controlled in such a way that a coating region can also be made thicker in respect of the layer thickness than other regions. The hardness of the coating is also adjustable, wherein other properties of the coating can also be adjusted by adding elements to the electrolyte or the electrolyte itself can be adjusted. It is especially edges or corners of the forming tool which are the focus of attention here. At the corners and edges of the forming tool, particularly high loads, including mechanical loads, can be expected, for which reason a particularly durable protective coating is advantageous here.

It is conceivable to produce a plurality of layers, i.e. successive coats, which together form the protective coating. It is possible to use electrolytes of different compositions to produce the individual layers, i.e. coats, with the result that the respective layer, i.e. coat, of the coating has certain properties and, overall, produces a particular protective coating. It is also expedient to produce all the layers, i.e. coats, of the protective coating using an identical electrolyte.

The protective coating can also be finished, that is to say, for example, polished.

It is in accordance with the present disclosure if a preform of the forming tool is first of all produced from the light metal. During this process, the forming punch and the corresponding mating die are produced approximately in the final shape. In a subsequent step, these can be machined, to remove flash, for example. However, it is expedient to finish-machine the respective preform in such a way that the forming tool has the negative shape to which the substrate to be formed is to be shaped. CNC methods or other suitable methods are expedient for the mechanical machining. There is the obvious advantage that aluminum is significantly easier to finish-machine than the steel previously used. Thus, it is also advantageous to produce not only the forming punch but also the, optionally immovable, mating die from the light metal. Admittedly, this is initially more expensive. However, this supposed disadvantage is more than canceled out by savings in machining time and especially weight.

Another advantage may also be seen in the fact that machining the forming tool formed from a light metal is significantly quicker, simpler and easier in comparison with a forming tool to be produced from a steel. As regards the preparation of prototype components, the forming tool according to the present disclosure can thus be used to particular advantage in respect of the stated parameters for the production of the forming tool. Of course, it is possible in each case to produce the forming tool, i.e. the forming punch and the mating die corresponding thereto, from a light metal block. In this case, the respective final shape can be produced by means of CNC methods or other suitable methods, for example.

Once the forming tool has the desired shape for shaping the substrate to be formed into the desired component, the forming tool is coated by means of PEO/PED, as described above.

Of course, the desired coating thickness of the protective coating is to be taken into account in the process of finish-machining.

The present disclosure also relates to a forming tool by means of which a substrate is to be formed. According to the present disclosure, the forming tool is formed from a light metal and, at least in some region or regions, has a protective coating applied by means of plasma electrolytic oxidation (PEO), i.e. microarc oxidation (MAO) or plasma electrolytic deposition (PED). It is in accordance with the present disclosure that the protective coating is produced by means of hard anodizing.

By means of the invention, it is possible, for example, to produce, i.e. appropriately form, load-bearing steel components, such as body components in the automotive industry, that is to say, for example, A, B, C or D pillars, but also components such as sills, a frame part and/or bumper supports etc., from high-strength heat-treated steels, such as boron-alloyed steel, e.g. 22MnB5. In this case, the pieces of sheet metal can be converted to the austenitic range by annealing at temperatures above 800° to 900° C., hot-formed and then cooled again at a sufficiently high cooling rate to achieve the formation of a martensitic high-strength microstructure. If quenching, i.e. cooling and thus hardening, takes place in the forming tool, the term “press hardening” is used, wherein the forming tool according to the present disclosure has the cooling channels and connections suitable for this purpose, which are known from conventional forming tools. However, the coated forming tool can withstand considerable thermal stress by virtue of the protective coating produced and embodied according to the present disclosure. By means of the forming tool according to the present disclosure, series production of the components mentioned at a considerable series volume can be achieved since the forming tools according to the present disclosure are made from the light metal with the protective coating according to the present disclosure, which have a very long life. By virtue of the light metal, the production of the forming tool according to the present disclosure is also quicker, simpler and easier in comparison with forming tools made of steel.

In the case of a direct forming process, the substrate, that is to say, for example, a blank or, for example, a steel element separated from a rolled strip is brought to said temperature. The heated substrate is then transferred to the subsequent hot forming system and is brought to the final shape there in the heated state in the forming tool according to the present disclosure, e.g. in a press. In an indirect forming process, on the other hand, the substrate is first of all cold-formed in a first forming tool, i.e. in a first press, then heated, that is to say probably annealed, and is then hot-formed in another press, i.e. brought to the final shape. The forming tool according to the present disclosure can be used both in cold forming and in hot forming.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a temperature profile in a forming tool made of steel during hot forming operations on a body component according to the prior art;

FIG. 2 shows the temperature profile during the hot forming of a body component by means of a forming tool made of a light metal and produced according to the present disclosure; and

FIG. 3 shows a forming punch systematically in a cross section.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the various figures, identical parts are in all cases provided with the same reference signs, for which reason these are also generally described only once.

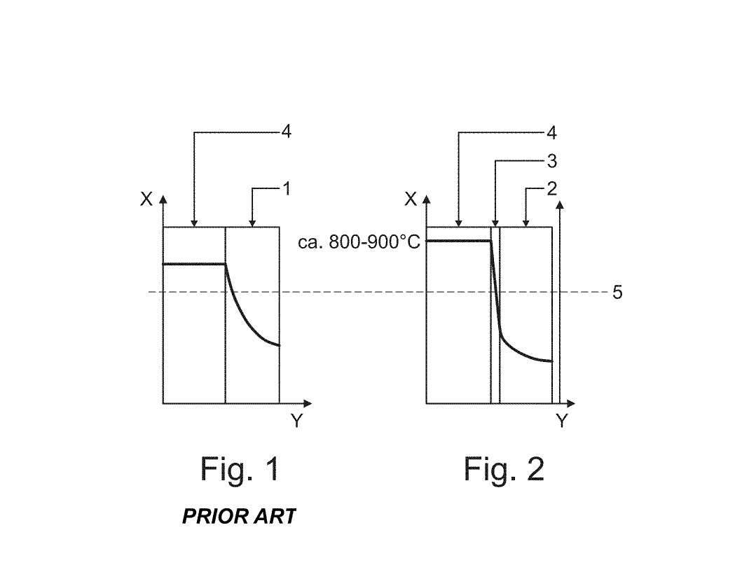

In FIGS. 1 and 2, the Y axis denotes the temperature, wherein the X axis denotes the distance of the sheet (substrate) to be hot-formed into a body component from the forming tool 1, 2. In FIG. 1, the forming tool 1 according to the prior art, which is made of a steel, is shown only schematically. In FIG. 2, the forming tool 2 according to the present disclosure, i.e. the forming tool produced from a light metal, is shown, although likewise schematically, and has a protective coating 3. The sheet to be hot-formed into a body component has the reference sign 4 in each case. The dashed line 5 denotes the melting temperature of the light metal, e.g. of aluminum.

It is expedient if the protective layer 3 is a heat insulation layer. The expedient form is illustrated by way of example by means of an aluminum tool (FIG. 2). The sheet 4 is transferred to the forming tool 2 at a temperature following austenitization, wherein the temperature is significantly above the melting temperature of the light metal (the melting temperature of pure aluminum is about 660° C., line 5). According to the present disclosure, by way of example, an oxidation layer, e.g. the protective coating 3, is applied to the forming tool 2, e.g. at least to the forming punch of the forming tool. Ideally, the protective coating 3 is hard, has a low friction coefficient and a low specific heat conduction (e.g. about 20× lower than steel). The heat input from the sheet is thus trapped in the boundary layer or protective coating 3 of the forming tool 2 at the beginning of hot forming. As soon as the heat coming in a delayed manner from the sheet transfers to the illustrative aluminum forming tool via the protective coating 3, the aluminum, by contrast, then conducts the heat away quickly (normally 3× better than steel). Thus, according to the present disclosure, rapid quenching of the sheet 4 and hence martensitic microstructure formation can be provided.

By virtue of the low specific heat conduction of the insulation layer, e.g. of the protective coating 3, the radiant heat is also dissipated more slowly than with conventional steel forming tools (FIG. 1). This means that the sheet can expediently be introduced into the forming tool 2 according to the present disclosure at a higher temperature than with steel forming tools 1. By virtue of the higher temperature of the material, the forming forces are also reduced and formability is enhanced.

This effect can be further reinforced by bilateral application of the protective coating 3, i.e. of the heat insulation layer, to the forming punch and to the corresponding mating die of the forming tool 2.

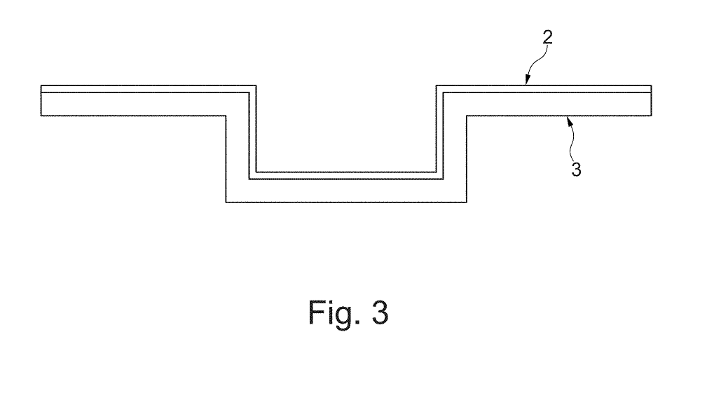

FIG. 3 shows a forming tool 2, that is to say, by way of example, the forming punch thereof as a detail, which has the protective coating 3 according to the present disclosure. Of course, the dimensions are shown in a distorted way. The protective coating 3 is oriented in the direction of the corresponding mating die (not shown) and is arranged over the full area and with the same thickness on the forming punch, purely by way of example. The mating die too can have the protective coating 3. It is in accordance with the present disclosure that the protective coating 3 is thicker in some region or regions than in other regions.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A method for producing a forming tool having a forming punch and a mating die corresponding to the forming tool for forming a substrate comprising the steps of:
preparing at least the forming punch of the forming tool from a light metal; and
forming a protective coating on at least one region on a surface of at least the forming punch of the forming tool.

2. The method according to claim 1, wherein the protective coating is produced by means of plasma electrolytic oxidation or plasma electrolytic deposition.

3. The method according to claim 1, wherein the protective coating is produced on the at least one surface region that is in contact with the substrate to be formed.

4. The method according to claim 1, wherein the protective coating is formed from a plurality of layers.

5. The method according to claim 1, wherein the forming punch and the mating die are produced as preforms from the light metal, wherein the preforms are finished to a final shape, wherein the protective coating is produced in one region of each final shape.

6. The method according to claim 1, wherein the forming punch and the mating die are each produced from a light metal block, wherein each light metal block is machined to give a final shape, wherein the protective coating is produced in at least one region of each final shape.

7. The method according to claim 1, wherein the protective coating is subsequently polished.

8. The method according to claim 1, wherein the protective coating is hard anodized.

9. A forming tool comprising:
a forming punch; and
a mating die corresponding to the forming punch,
wherein at least the forming punch is formed of a light metal and defines at least one region having a protective coating that is configured to come into contact with a substrate to be formed.

10. The forming tool according to claim 9, wherein the forming punch is formed from aluminum or from an aluminum alloy.

11. The forming tool according to claim 9, wherein both the forming punch and the mating die are formed from light metal.

12. The forming tool according to claim 9, wherein the protective coating is at least one of a heat protective coating and an antiwear coating.

13. The forming tool according to claim 9, wherein the protective coating has a hardness of up to 2000 HV.

14. The forming tool according to claim 9, wherein the protective coating is applied in a uniform thickness.

15. The forming tool according to claim 14, wherein the uniform thickness is between 10 μm and 200 μm.

16. The forming tool according to claim 9, wherein the protective coating has a variable hardness.

17. A forming tool comprising:
a forming part; and
a mating die corresponding to the forming part,
wherein at least the forming part is formed of a light metal and defines at least one region having a protective coating that is configured to come into contact with a substrate to be formed.

18. The forming tool according to claim 17, wherein the forming tool defines at least one edge on at least one of the forming part and the mating die, and the protective coating is disposed on the at least one edge.

19. The forming tool according to claim 17, wherein the forming part and the mating die are formed from a light metal.

20. The forming tool according to claim 17, wherein the light metal is aluminum or an aluminum alloy.
